(19) United States
(12) Patent Application Publication
(10) Pub. No.: US 2002/0125084 A1
(43) Pub. Date: Sep. 12, 2002

(54) Device for damping vibrations in a steering wheel

(75) Inventors: Martin Kreuzer, Kleinwallstadt (DE); Udo Bieber, Niedernberg (DE); Christian Lorenz, Leidersbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co. KG

(21) Appl. No.: 10/092,871

(22) Filed: Mar. 7, 2002

(30) Foreign Application Priority Data
Mar. 8, 2001 (DE) 201 04 043.3

(51) Int. Cl. F16F 9/53

(52) U.S. Cl. 188/267.1

(57) ABSTRACT

The invention relates to a device for damping vibrations in a steering wheel. The device comprises a damping means and an attenuation mass connected with the damping means. An electrical control unit is provided which is coupled with the damping means. The control unit is able to alter mechanical vibration characteristics of the device such that different vibration frequencies can be damped.

### TECHNICAL FIELD

The invention relates to a device for damping vibrations in a steering wheel.

### BACKGROUND OF THE INVENTION

Such a device usually comprises a damping means and an attenuation mass connected with the damping means, for damping vibrations of the steering wheel that are experienced as disturbing by the driver. The vibrating of a steering wheel is influenced by various parameters. Any resilience in longitudinal direction of the rear axle suspension converts the vibrations, introduced as a result of an imbalance of the wheels on the rear axle, to a horizontal vibration of the bodywork and hence to a vertical vibration of the steering wheel. Engine vibrations, specifically in diesel vehicles, often lead in idling to vibrations on the steering wheel. In order to damp the vibrations introduced into a steering wheel, often a force directed in opposition to the direction of movement is applied. For this, spring mass systems are used, which are also known as vibration dampers.

Vibration dampers are known which consist of metal masses mounted in rubber elastic, these vibration dampers being tuned so as to be effective at particular frequencies. Generally, such vibration dampers are fastened to the steering wheel hub. As attenuation mass also a gas generator of a gas bag module arranged in the steering wheel can be used, or the gas bag module itself is utilized for vibration damping.

Thus, for example in EP-A 0 827 878 the damping of the steering wheel vibrations takes place via springs arranged concentrically around the gas bag module, which springs rest on the steering wheel body.

A substantial disadvantage in the vibration dampers described lies in that they are only tuned to be effective at one frequency. Owing to the various influences of the path which is traveled and the changeable engine vibrations with different rotation rates, however, the frequency of the steering wheel vibration changes at any time. A majority of the steering wheel vibrations therefore remains undamped.

### BRIEF SUMMARY OF THE INVENTION

It is an object of the invention to improve the vibration damping of a steering wheel.

This is achieved in a device, for damping vibrations in a steering wheel, which comprises a damping means and an attenuation mass connected with the damping means. An electrical control unit is provided which is coupled with the damping means. The control unit is able to alter mechanical vibration characteristics of the device such that different vibration frequencies can be damped. By means of the mechanical vibration characteristics of the device, its vibration frequency is influenced, so that the vibration frequency of the device can be adapted to the present vibration frequency of the steering wheel, in order for example to achieve a resonance damping. The device, hereinafter also known as a vibration damper, can therefore be tuned in a flexible manner to the actual present vibration frequency of the steering wheel, so that chronologically variably different vibrations can be damped.

In a preferred embodiment of the invention, the damping means is designed such that the mechanical vibration characteristics of the device can be altered by the supply of electrical energy to the damping means. The supply of electrical energy can take place by producing a current flow, by applying a voltage or by applying an electric field. The supply of electrical energy can be controlled in a simple and flexible manner by the electric control unit, so that the vibration damper can be adjusted quickly and continuously in its vibration frequency.

Preferably, through coupling with a sensor, the control unit receives data regarding present vibrations of the steering wheel, so that the vibration frequency of the vibration damper can always be tuned to the present vibration frequency of the steering wheel.

The change to the mechanical vibration characteristics is preferably achieved in that the damping means contains a material which with a supply of electrical energy alters its mechanical characteristics. In this way, mechanically adjustable devices can be dispensed with, which simplifies the construction of the device and increases its lifespan. The material is preferably an electrically conductive elastomer. The elastomer advantageously contains electrically conductive particles, e.g. soot or metal particles. Particularly advantageously, polarizable particles can be used. Through a flow of current through the elastomer, the position of such particles can be altered, with site interchange reactions occurring, so that the mechanical characteristics of the polymer matrix can be influenced.

In another preferred embodiment of the invention, the material is an electrorheological fluid. The viscosity of such fluids can be influenced in a wide range by means of the application of an electrical field, whereby the vibration frequency of the vibration damper can be altered in a very flexible manner.

In a further preferred embodiment of the invention, the damping means comprises a bimetal strip. With a through-flow of current, the bimetal strip becomes heated and alters its curvature and hence its vibration frequency. Bimetal strips react very quickly to a temperature change, so that through a through-flow of current, a rapid and precise tuning of the vibration frequency can be achieved.

In a further preferred embodiment of the invention, the damping means comprises a damping body and a magnet surrounding the damping body. The magnet is preferably an electromagnet.

The material of the damping body can be an electrically conductive elastomer. The alteration to the vibration characteristics can in this case either take place in that the flow of current is altered in the surrounding electromagnet or by the flow of current being altered within the preferably annular damping body.

In an advantageous further development of the invention, the damping body contains a magnetorheological fluid. The viscosity of such a fluid alters according to the strength of the magnetic field in which the fluid is situated. In this way, by means of the alteration to the flow of current in the electromagnet surrounding the damping body, a rapid and simple alteration to the vibration frequency of the device can be achieved.

Preferably, a gas generator of a gas bag module arranged in the steering wheel fulfils the task of the attenuation mass. In this way, no further mass has to be arranged in the steering wheel, whereby the weight of the steering wheel would be increased unnecessarily.

### BRIEF DESCRIPTION OF THE DRAWINGS

FIG. 1 shows a section through a steering wheel with a device of the invention in accordance with a first and a second embodiment, which are illustrated in the right and left halves of the drawing, respectively;

FIG. 2 shows a section through a steering wheel with a device of the invention in accordance with a third embodiment;

FIG. 3 shows a section through a steering wheel with a device of the invention in accordance with a fourth embodiment;

FIG. 4 shows detail Z of FIG. 3 on an enlarged scale; and

FIG. 5 shows a section through a steering wheel with a device of the invention in accordance with a fifth embodiment.

### DETAILED DESCRIPTION OF THE PREFERRED EMBODIMENTS

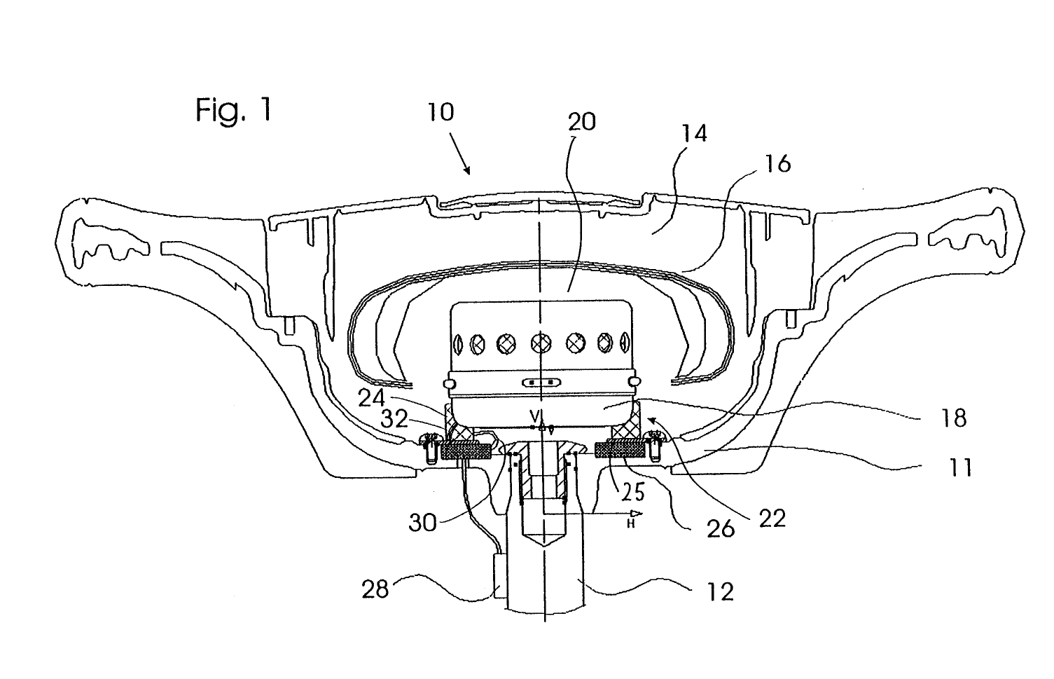

FIG. 1 shows a steering wheel 10, which is fastened in a known manner to a steering wheel column 12. Inside the steering wheel 10, a gas bag module 14 is arranged which comprises a gas bag 16 and a gas generator 18. The gas generator 18 or, in a variant, the entire gas bag module 14, forms an attenuation mass of a vibration damper 20, which in addition to the attenuation mass has a damping means 22 connected with the steering wheel skeleton 11 and which forms a device for damping vibrations in a steering wheel.

The damping means 22 comprises a damping body 24 which is connected with a metal sheet 25 fastened to the steering wheel skeleton 11 and with the attenuation mass. The vibration damper 20 comprises in addition an electrical control unit 26 which is coupled with the damping means 22.

The control unit 26 is preferably connected with an acceleration sensor 28, which is arranged on the steering column 12 and measures its vibrations and transmits these data to the control unit 26.

The vibration damper 20 serves principally for damping vertical steering wheel vibrations, in the direction of the axis V illustrated in the drawing, but also brings about a reduction to the vibration components in the direction of the illustrated axis H.

In a first embodiment of the invention (right-hand half of the drawing), the damping body 24 comprises an electrically conductive elastomer, which contains for example soot particles or metal particles which may advantageously be magnetically polarizable. The damping body 24 is preferably ring-shaped. The damping body 24 is connected with the control unit 26 via leads 30.

The elastomer is selected such that on application of an electrical voltage to the damping body 24 or on setting of an electrical current flow through the damping body 24, the hardness and hence the vibration characteristics of the damping body 24 alter.

The setting of the supply of electrical energy can take place on the basis of previously derived correlations.

The mode of operation of the vibration damper according to the first embodiment 20 is as follows. The acceleration sensor 28 on the steering wheel 12 measures the frequency of the vertical component of the steering wheel vibration. The control unit 26 receives these data from the acceleration sensor 28 and causes a corresponding supply of electrical energy in the form of current, voltage or an electrical field to the damping body 24. The elastomer material of the damping body 24 preferably changes its hardness under the influence of the electrical energy, so that the vibration characteristics of the damping body 24 alter. In this way, the vibration frequency of the vibration damper 20 can be tuned exactly to the present vibration frequency of the steering wheel 10, so that for example a resonance damping is able to be achieved and the vibration amplitude of the steering wheel is reduced.

The values required for determining the supply of electrical energy are preferably determined in preliminary tests and are stored in the control unit 26.

In a second embodiment (left-hand half of the drawing), bimetal strips 32 are embedded into the damping body 24. Through a flow of current, set by the control unit 26, through the damping body 24 and the bimetal trips 32, respectively, the bimetal strips 32 are heated and change their curvature as a function of the temperature. Thereby, the inherent frequency of the damping body 24 can be adapted in order, as described above, to damp the steering wheel vibration.

The bimetal strips 32 do not have to be embedded in the damping body 24. In this case, however, it is important that the bimetal strips 32 are firmly connected both with the gas generator 18 and also with the steering wheel skeleton 11.

In another variant to this embodiment, provision is made that the damping body 24 contains an electrorheological fluid. With such fluids, by the application of an electrical field the viscosity can be altered within a wide range and in a very short response time. By application of a voltage to the damping body 24, accordingly its vibration frequency can be set to the value required for the respective situation.

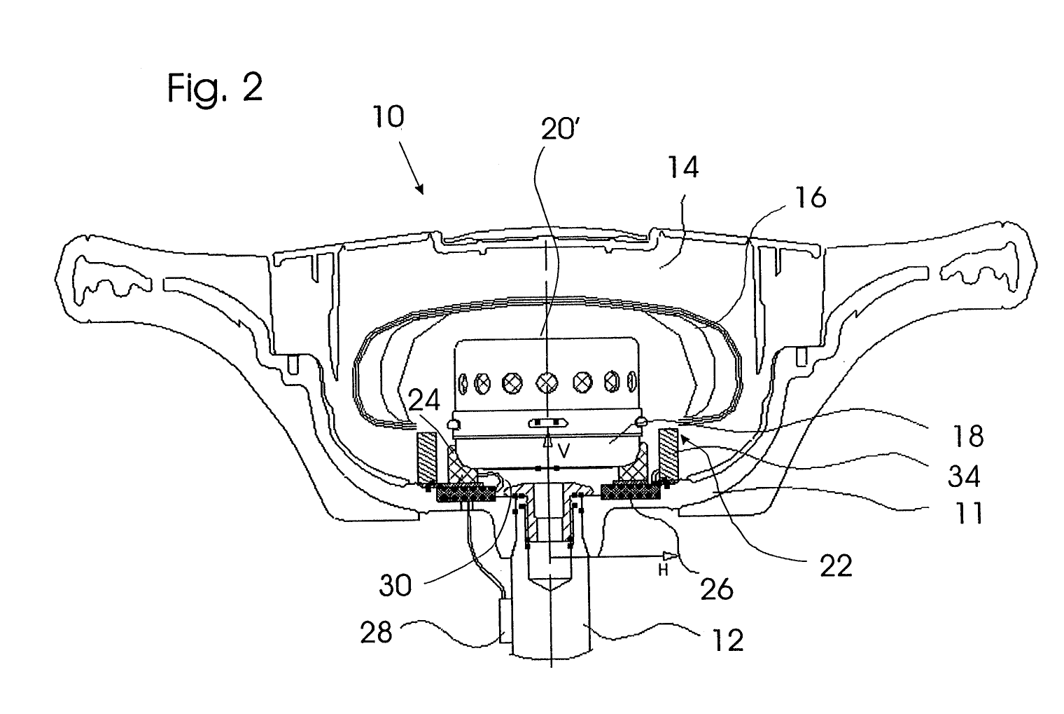

The vibration damper 20′ of the steering wheel 10 illustrated in FIG. 2 differs from that shown in FIG. 1 in that the damping means 22 comprises a damping body 24 and a magnet 34 arranged around the damping body 24.

In this embodiment of the invention, the magnet 34 is an electromagnet, whereas the damping body 24 preferably comprises a ring of an electrically conductive elastomer. The control unit 26 alters the flow of current through the electromagnet as a function of the present vibration of the steering wheel and hence alters the electromagnetic field prevailing in its interior. The currents thus induced in the damping body 24 alter the vibration frequency of the vibration damper 20′, so that, adapted to the present vibration of the steering wheel, different frequencies can be damped.

In a variant to this embodiment of the invention, the field intensity of the magnetic field of the magnet 34 is not altered, but rather the current flow through the elastomer ring of the damping body 24. The magnetic field thus generated and its alteration have an effect on the vibration characteristics of the vibration damper 20′, so that an adapted damping can be achieved. In this embodiment, the magnet 34 can also be a permanent magnet.

In another variant to this embodiment of the invention, the damping body 24 contains a magnetorheological fluid. Similar to the electrorheological fluids described above, such fluids alter their viscosity as a function of the magnetic field in which they are situated. By means of an alteration to the field of the electromagnet 34, the vibration frequency of the vibration damper 20′ can thus be adjusted.

The control unit 26 can also be supplied with data from sources other than the acceleration sensor 28. The control unit 26 can in addition be designed to release the gas bag module.

According to the embodiment of FIG. 3, the mass of the gas generator is involved in vibration damping. For this, the damping means 22 comprises a damping body 24 by means of which the gas generator 18 is connected with the steering wheel.

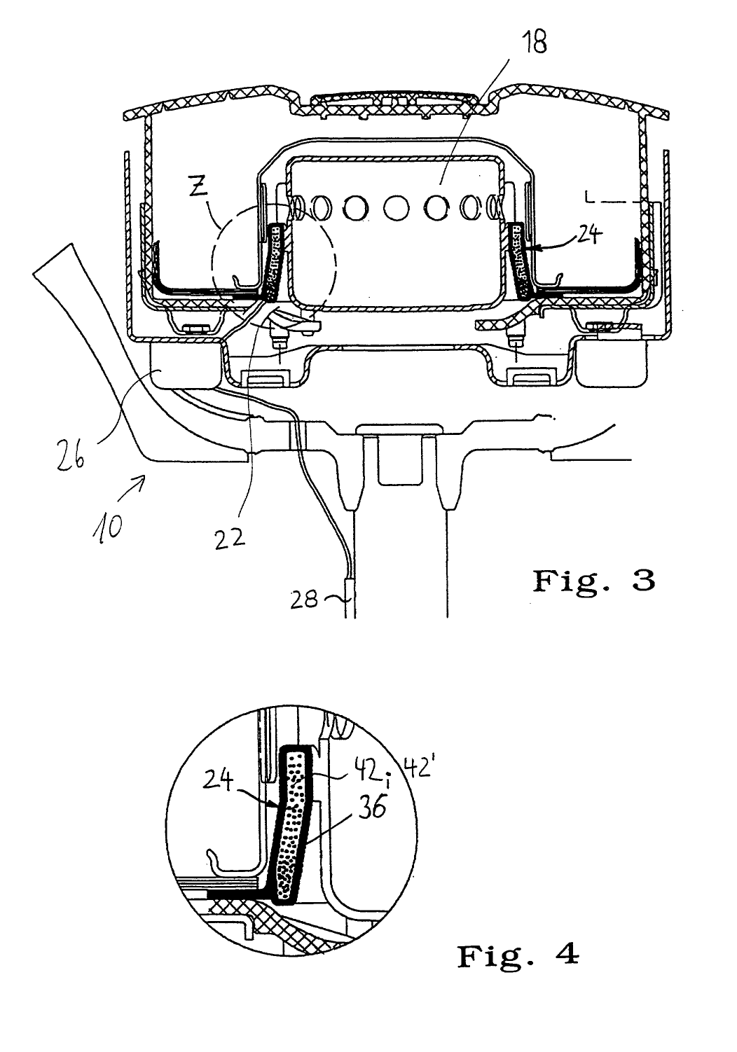

FIG. 4 illustrates detail Z of FIG. 3 on an enlarged scale. It is to be seen that the damping body 24 in the region of its upper edge is connected with the gas generator, and features at its lower edge a lip that may be clamped between a gas bag holding metal plate and a bottom part of the module. The bottom part may be connected with the steering wheel skeleton in a conventional manner.

In this arrangement, the damping body 24 is comprised of a ring-shaped hollow body 36 made of an elastic material such as an elastomer. This hollow body 36 is filled with an electrorheological fluid 42.

An acceleration sensor 28 is provided on the steering column end, which sensor detects the incoming vibration as a resultant acceleration and passes the signal to a control unit 26 accommodated in the steering wheel. Corresponding to a correlation derived from preliminary tests, the control unit 26 has influence on an electrical signal to electrodes (not shown). As a result of this, the electrorheological fluid alters its viscosity, whereby an adaptive damping is made possible.

By tuning an electrical field in the region of the damping body 24, it is possible to set the vibration frequency of the vibration system, consisting of gas generator and damping body, to the value required in each case.

Instead of an electrorheological fluid, it is also possible to use a magnetorheological fluid. Such fluids alter their viscosity when subjected to a varying magnetic field. Hence, a damping body 24 filled with a magnetorheological fluid 42′ is to be surrounded with an electromagnet analogue to the embodiment of FIG. 2, in order to be able to lead to the required alteration of viscosity.

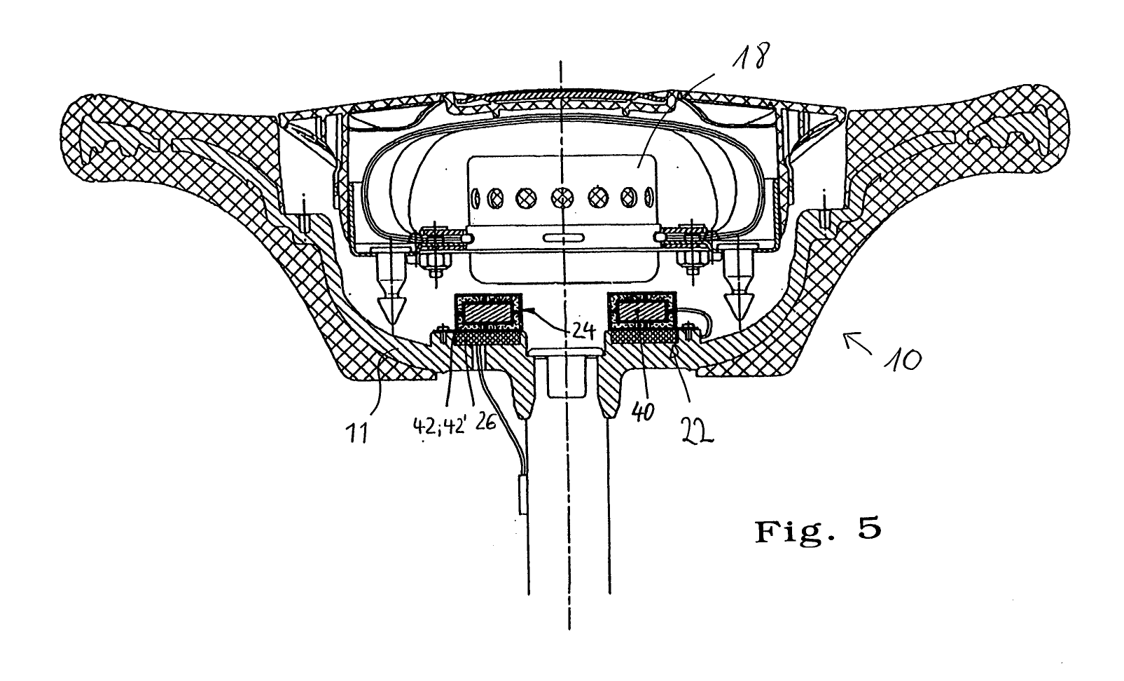

In FIG. 5 there is shown an arrangement in which—in contrast to the previously described embodiments—the mass of the gas generator 18 is not directly included in the vibration system. Here, a damping means 22 is provided in the region of the hub of the steering wheel 10, this damping means comprising a mass core 40 arranged in a damping body 24. The mass core 40 may be a ring-shaped, preferably circular body made of metal, for instance, which is surrounded by an electrorheological or magnetorheological fluid 42, 42′. Here too, the outer skin is formed by a leakproof, ring-shaped hollow body 36 which may be made of an elastomer. When a specific electric or magnetic field is applied, the viscosity is altered, i.e. becomes somewhat “harder”; this having influence on the vibration amplitude of the incorporated mass core and, thus, on the vibration characteristics of the whole system.

It is true for all embodiments discussed above that the type and the arrangement of the electrodes or magnets, by means of which the electrorheological or magnetorheological fluid is acted upon with an electric or magnetic field, is not of importance and, consequently, not described in further detail here.

1. A device for damping vibrations in a steering wheel, said device comprising a damping means, an attenuation mass connected with said damping means and an electrical control unit coupled with said damping means, said control unit being able to alter mechanical vibration characteristics of said device such that different vibration frequencies can be damped.

2. The device according to claim 1, wherein said damping means is designed such that said mechanical vibration characteristics of said device can be altered by supplying electrical energy to said damping means.

3. The device according to claim 1, wherein a sensor is provided, through which said control unit receives data regarding said vibrations of said steering wheel.

4. The device according to claim 2, wherein said damping means comprises a material which alters its mechanical characteristics with said supply of electrical energy.

5. The device according to claim 4, wherein said material is an electrically conductive elastomer.

6. The device according to claim 4, wherein said material is an electrorheological fluid.

7. The device according to claim 1, wherein said damping means comprises a bimetal strip.

8. The device according to claim 1, wherein said damping means comprises a damping body and a magnet surrounding said damping body.

9. The device according to claim 8, wherein said magnet is an electromagnet.

10. The device according to claim 9, wherein said damping body contains an electrically conductive elastomer.

11. The device according to claim 9, wherein said damping body contains a magnetorheological fluid.

12. The device according to claim 1, wherein said damping body is a hollow body made of an elastic material.

13. The device according to claim 12, wherein said hollow body is ring-shaped.

14. The device according to claim 12, wherein a mass core acting as said attenuation mass is incorporated in said hollow body.

15. The device according to claim 12, wherein said hollow body contains one of an electrorheological and magnetorheological fluid.

16. The device according to claim 1, wherein said attenuation mass is a gas generator.

17. The device according to claim 1, wherein said attenuation mass is a gas bag module.
